(19) United States
(12) Patent Application Publication
(10) Pub. No.: US 2007/0248229 A1
(43) Pub. Date: Oct. 25, 2007

(54) Quantum cipher communication system and method of setting average photon number at communication terminal

(75) Inventors: Yohei Kawamoto, Tokyo (JP); Takuya Hirano, Tokyo (JP); Kuninori Shino, Tokyo (JP); Masakazu Ukita, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/725,158

(22) Filed: Mar. 15, 2007

(30) Foreign Application Priority Data
Mar. 16, 2006 (JP) P2006-073449

(51) Int. Cl. H04K 1/00

(52) U.S. Cl. 380/256

(57) ABSTRACT

A quantum cipher communication system performs communication processing based on quantum cipher. It may have a first communication terminal, a second communication terminal, and a communication path that connects them. The first communication terminal may contain an optical source, a first light-separating device, optical paths, a light-synthesizing device, a second light-separating device, a first phase-modulator, and a homodyne detector that performs homodyne detection based on the reference light separated in the second light-separating device and passed through the first optical path and the signal light separated in the second light-separating device and passed through the second optical path. The second communication terminal may contain a light-sending device, an optical attenuator, a second phase-modulator, and a photon-number-setting device that sets to a predetermined value an average photon number of the signal light sent to the communication path from the light-sending device.

### CROSS-REFERENCE TO RELATED APPLICATIONS

This application claims priority from Japanese Patent Application No. JP 2006-073449 filed in the Japanese Patent Office on Mar. 16, 2006, the entire content of which is incorporated herein by reference.

### BACKGROUND OF THE INVENTION

1. Field of the Invention

The present invention relates to a quantum cipher communication system that performs communication processing based on quantum cipher and a method of setting an average photon number at a communication terminal, which is used in the quantum cipher communication system.

2. Description of Related Art

Public key cryptosystems including an RAS cipher and an EL Gamal cipher and common key cryptosystem including an advanced encryption standard (AES) cipher and a data encryption standard (DES) cipher are in common use for preventing any information from being leaked to a third party. In the public key cryptosystems, their security is secured based on a difficulty in solution to factorization into prime numbers or a difficulty in solution to a discrete logarithm program. The security is exposed to deciphering of their codes by a quantum computer or unknown threat. In the common key cryptosystem, the private key may be necessary for being previously shared by a sender and a receiver so that the private key is shared ordinarily using any public key cryptosystems. Advanced attacking method thereon could cause efficient deciphering of their codes to be developed in the future.

Any absolute indecipherable ciphers such as Vemam cipher, security of which is secured based on a large amount of information, has been proposed. Such the absolute indecipherable ciphers have a large size of a key shared by a sender and a receiver for implementing their absolute indecipherability, as indicated by Shannon, so that it is difficult to distribute the key.

Bennett et al have proposed quantum cipher as the breakthrough method thereto. The quantum cipher refers to as a cipher in which a private key can be shared by utilizing a principle of quantum mechanics. The principle that if weak light situation is measured even by one time, its situation is changed so that such the situation can be measured with less accuracy is utilized. Implementing method of such the quantum cipher is roughly specified into two categories based on measurement methods of weak signal light.

One method is based on single photon detection and the other method is based on homodyne detection. In the single photon detection, a single photon is produced and detected, which is its feature but weak point. In the homodyne detection, a homodyne detector constituted of a photo diode detects weak coherent light emitted from a laser diode. The homodyne detection can perform a high efficient measurement at room temperature, which has a bright future.

Japanese Patent Application Publication NO. 2000-101570 has disclosed quantum cipher protocol based on the homodyne detection. Further, Japanese Patent Application Publication NO. 2005-286485 has disclosed plug and play implement that can deal with disturbance on polarization of an optical fiber and a difference of optical path length thereof, which are difficult to be avoided in a long-distance communication. The above Japanese publication No. 2005-286485 has also disclosed a method for synchronizing a sender to a receiver and vice versa.

### SUMMARY OF THE INVENTION

In the quantum cipher protocol, secret information is carried by pulse light as an amount of phase modulation but any functions of the quantum cipher can be attained in only a weak level such that its average photon number of signal light is almost one for each pulse. If an average photon number of the signal light having a weak level is accurately set at output of a sender who sending the secret information, it is possible for a receiver to detect a risk of any wiretapping by estimating the average photon number by the receiver after the receiver measures the signal light and comparing the estimated average photon number with the average photon number set at the output of the sender.

It may be desirable to provide a quantum cipher communication system that performs communication processing based on quantum cipher and a method of setting an average photon number at a communication terminal of a sender accurately, which is used in the quantum cipher communication system, by which it may be possible to detect a risk of any wiretapping.

According to an embodiment of the invention, there is provided a quantum cipher communication system, which may perform communication processing based on quantum cipher, containing a first communication terminal, a second communication terminal, and a communication path that connects the first communication terminal and the second communication terminal. The first communication terminal may contain an optical source that emits pulse light, a first light-separating device that separates signal light and reference light from the pulse light emitted from the optical source. The first communication terminal may also contain a first optical path into which a delaying device is inserted, a second optical path into which no delaying device is inserted, and a light-synthesizing device that synthesizes the signal light separated in the first light-separating device and passed through the first optical path with the reference light separated in the first light-separating device and passed through the second optical path to send the synthesized light to the communication path. The first communication terminal may further contain a second light-separating device that separates signal light and reference light from the pulse light returned from the second communication terminal through the communication path. The first communication terminal may additionally contain a first phase-modulator that performs random phase-modulation on the reference light separated in the second light-separating device and passed through the first optical for each pulse, and a homodyne detector that performs homodyne detection based on the reference light separated in the second light-separating device and passed through the first optical path and the signal light separated in the second light-separating device and passed through the second optical path.

The second communication terminal may contain a light-sending device that sends the signal light and the reference light to the communication path via a predetermined optical path, the signal light and the reference light being sent from the first communication terminal through the communication path, and an optical attenuator that attenuates the signal light passing through the predetermined optical path. The second communication terminal may also contain a second phase-modulator that performs random phase-modulation on the signal light passing through the predetermined optical path for each pulse, and a photon-number-setting device that sets to a predetermined value an average photon number of the signal light that is sent to the communication path from the light-sending device.

In this embodiment, the quantum cipher communication system may have a first communication terminal, which is a terminal on the receiver side, a second communication terminal, which is a terminal on the sender side, and a communication path that connects the first and second communication terminals. The communication path may be constituted of an optical fiber or free space.

The pulse light emitted from the optical source of the first communication terminal (the terminal on the receiver side) may be separated into signal light and reference light by the first light-separating device. The signal light passed through the first optical path into which a delaying device is inserted and the reference light passed through the second optical path into which no delaying device is inserted may be combined and then, the combined light may be sent to the communication path. In this moment, the reference light may be first sent to the communication path and the signal light may then be sent to the communication path after a predetermined period of time has been elapsed.

The second communication terminal (the terminal on the sender side) may receive the reference light and the signal light through the communication path. The reference light and the signal light may be returned to the communication path via a predetermined optical path. In this embodiment, the optical attenuator may attenuate this signal light passed through the predetermined optical path, so that an intensity of the attenuated signal light that is then sent to the communication path becomes weak. On the other hand, the reference light passed through the predetermined optical path may not be attenuated, so that an intensity of the reference light that is then sent to the communication path remains strong as compared with that of the signal light. The second phase-modulator may perform random phase-modulation on the signal light passing through the predetermined optical path for each pulse. This may enable secret information to be carried on the signal light as an amount of phase modulation.

For example, a second light-splitting device may split a part of the light sent from the first communication terminal through the communication path and a second light-detecting device detects an arrival of the reference light based on a split output from the second light-splitting device. Processing starts of the second phase-modulator and the optical attenuator may be controlled based on a detected output indicating the arrival of the reference light. This may allow each pulse constituting the signal light to be phase-modulated and attenuated at a proper timing. The photon-number-setting device may set to a predetermined value an average photon number of the signal light that may again be sent to the communication path from the predetermined optical path. For example, a first detector may detect an intensity of the signal light sent from the first communication terminal through the communication path. A second detector may detect an intensity of the signal light after the signal light is attenuated by the optical attenuator. An intensity-estimating device may estimate an intensity value of the second detector based on the detected intensity of the first detector and the set value of the average photon number of the signal light that is sent to the communication path. An amount-of-attenuation-directing device may direct an amount of attenuation in the optical attenuator so that the detected intensity of the second detector becomes the estimated intensity value of the second detector in the intensity-estimating device.

To the first communication terminal (the terminal on the receiver side), the reference light and the signal light may be returned through the communication path. The second light-separating device may separate the signal light and the reference light from the returned pulse light. The signal light may be passed through the first optical path and the reference light has been passed through the second optical path when the signal light and the reference light are sent from the first communication terminal to the second communication terminal, as described above, while the reference light is passed through the first optical path and the signal light is passed through the second optical path when the signal light and the reference light are returned from the second communication terminal to the first communication terminal.

The first phase-modulator may perform random phase-modulation on the reference light passed through the first optical for each pulse. The homodyne detector may perform homodyne detection based on the reference light passed through the first optical path and the signal light passed through the second optical path. From the detected information by the homodyne detector, the secret information including a private key carried on the signal light in the second communication terminal, as described above, can be obtained.

For example, a first light-splitting device may split a part of the reference light sent from the second communication terminal through the communication path. A first light-detecting device may detect an arrival of the reference light based on a split output from the first light-splitting device. Processing start of the first phase-modulator may be controlled based on a detected output indicating the arrival of the reference light. This may enable each pulse constituting the reference light to be phase-modulated at a proper timing.

Thus, in this embodiment, between the first and second communication terminals, a shuttle communication path may be formed. In the first communication terminal, the signal light and the reference light passed through the first and second optical paths may be replaced in passed paths when the signal light and the reference light are returned so that the signal light and the reference light pass by the same distance as each other. This may enable any interference measurement of the homodyne detector to be exactly executed, thereby solving any disturbance on polarization within the communication path.

It is to be noted that the first communication terminal may contain a photon-number-estimating device that estimates an average photon number of the signal light which is sent to the communication path from the second communication terminal. Further, the first communication terminal may contain a photo-number-verifying device verifying that the estimated average photon number of the signal light in the photon-number-estimating device is made identical to the set average photon number of the signal light in the photon-number-setting device in the second communication terminal. Thus, estimating the average photon number of the signal light and then, verifying that the estimated average photon number of the signal light is made identical to the set average photon number of the signal light allow any wiretap to be detected. In this embodiment, since the average photon number of the signal light which the second communication terminal sends to the communication path may be set to a predetermined value, it is easy to detect the wiretap by such the verification.

According to another embodiment of the invention, there is provided a quantum cipher communication system that performs communication processing based on quantum cipher. The quantum cipher communication system may have a first communication terminal, a second communication terminal, and a communication path that connects the first communication terminal and the second communication terminal.

The first communication terminal may contain a first light-separating device that separates signal light and reference light from light sent from the second communication terminal through the communication path, a first optical path, a second optical path having a shorter length than that of the first optical path. The first communication terminal may also contain a first phase-modulator that performs random phase-modulation on the reference light separated in the first light-separating device and passed through the first optical for each pulse, and a homodyne detector that performs homodyne detection based on the reference light separated in the first light-separating device and passed through the first optical path and the signal light separated in the first light-separating device and passed through the second optical path.

The second communication terminal may contain an optical source that emitting pulse light, and a second light-separating device that separates the signal light and the reference light from the pulse light emitted from the optical source. The second communication terminal may also contain a third optical path having a length of optical path that corresponds to that of first optical path of the first communication terminal, a fourth optical path having a length of optical path that corresponds to that of the second optical path of the first communication terminal, and an optical attenuator that attenuates the signal light passing through the third optical path. The second communication terminal may further contain a second phase-modulator that performs random phase-modulation on the signal light passing through the third optical path for each pulse and a light-sending device that synthesizes the signal light separated in the second light-separating device and passed through the third optical path with the reference light separated in the second light-separating device and passed through the fourth optical path to send the synthesized light to the communication path. The second communication terminal may additionally contain a photon-number-setting device that sets to a predetermined value an average photon number of the signal light that is sent to the communication path from the light-sending device.

In this embodiment, the quantum cipher communication system may have a first communication terminal, which is a terminal on the receiver side, a second communication terminal, which is a terminal on the sender side, and a communication path that connects the first and second communication terminals. The communication path may be constituted of an optical fiber or free space.

The pulse light emitted from the optical source of the second communication terminal (the terminal on the sender side) may be separated into signal light and reference light by the second light-separating device. The optical attenuator may attenuate the signal light passed through the third optical path so that an intensity of the signal light that is sent to the communication path becomes weak. On the other hand, the reference light passed through the fourth optical path may not be attenuated, so that an intensity of the reference light that is then sent to the communication path remains strong as compared with that of the signal light. The second phase-modulator may perform random phase-modulation on the signal light passing through the third optical path for each pulse. This may enable secret information to be carried on the signal light as an amount of phase modulation. The signal light passed through the third optical path and the reference light passed through the fourth optical path may be combined and then, the combined light may be sent to the communication path.

The photon-number-setting device may be set to a predetermined value an average photon number of the signal light that is sent to the communication path. For example, a detector may detect an intensity of light leaked from the optical attenuator accompanying with its attenuation processing. An amount-of-attenuation-directing device may direct an amount of attenuation in the optical attenuator based on the detected intensity of the detector and the set value of the average photon number of the signal light that is sent to the communication path.

To the first communication terminal (the terminal on the receiver side) may receive the reference light and the signal light through the communication path. The first light-separating device may separate the signal light and the reference light. The signal light may be passed through the second optical path having a length of optical path that corresponds to that of fourth optical path of the second communication terminal. The reference light may be passed through the first optical path having a length of optical path that corresponds to that of the third optical path of the second communication terminal.

The first phase-modulator may perform random phase-modulation on the reference light passed through the first optical path for each pulse. The homodyne detector may then perform homodyne detection based on the reference light passed through the first optical path and the signal light passed through the second optical path. From the detected information by the homodyne detector, the secret information including a private key carried on the signal light in the second communication terminal, as described above, may be obtained.

It is to be noted that the first communication terminal may contain a photon-number-estimating device that estimates an average photon number of the signal light which is sent to the communication path from the second communication terminal. Further, the first communication terminal may contain a photo-number-verifying device verifying that the estimated average photon number of the signal light in the photon-number-estimating device is made identical to the set average photon number of the signal light in the photon-number-setting device in the second communication terminal. Thus, estimating the average photon number of the signal light and then, verifying that the estimated average photon number of the signal light is made identical to the set average photon number of the signal light allow any wiretap to be detected. In this embodiment, since the average photon number of the signal light which the second communication terminal sends to the communication path may be set to a predetermined value, it may be easy to detect the wiretap by such the verification.

According to the embodiments of the invention, the terminal on the sender side may send the reference light having a comparative strong intensity thereof and the signal light having a weak intensity thereof, on which any random phase-modulation may be performed to the terminal on the receiver side. The terminal on the receiver side may further perform random phase-modulation on the reference light and then, the homodyne detection may be executed based on the reference light and the signal light. The terminal on the sender side may have a setting portion that set to a predetermined value the average photon number at an output of the terminal on the sender side so that the average photon number of the signal light at the output of the terminal on the sender side may be accurately set. This may allow any detection of the wiretap to be easily performed.

The concluding portion of this specification particularly points out and directly claims the subject matter of the present invention. However, those skilled in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIG. 1 is a block diagram for showing a configuration of an embodiment of a quantum cipher communication system 100 according to the invention;

FIG. 2A is a diagram for showing information communication processing (No. 1) and FIG. 2B is a table for describing the processing;

FIG. 3A is a diagram for showing information communication processing (No. 2) and FIG. 3B is a table for describing the processing;

FIG. 4A is a diagram for showing information communication processing (No. 3) and FIG. 4B is a table for describing the processing;

FIG. 5 is a flowchart for showing a procedure of average photo number setting, average photon number estimating, and average photon number verifying; and

FIG. 6 is a block diagram for showing a configuration of another embodiment of a quantum cipher communication system 200 according to the invention.

### DETAILED DESCRIPTION

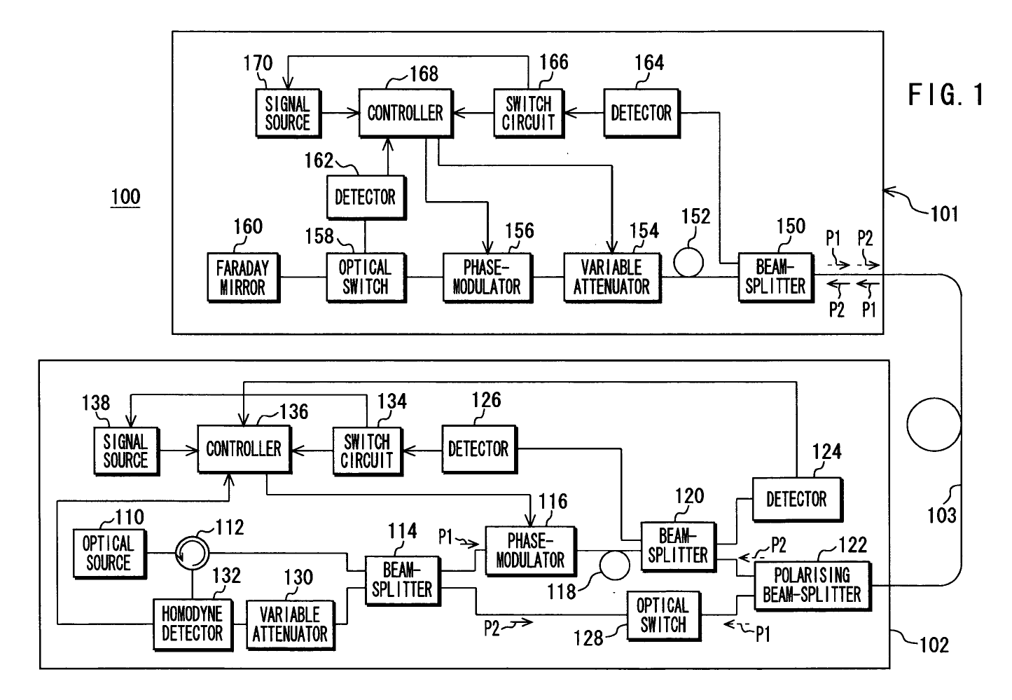

The following will describe embodiments of the present invention with reference to the drawings. FIG. 1 shows a configuration of an embodiment of a quantum cipher communication system 100 according to the invention.

The quantum cipher communication system 100 has a terminal 101 on a sender side (hereinafter referred to as “sender 101”) as a first communication terminal, a terminal 102 on a receiver side (hereinafter referred to as “receiver 102”) as a second communication terminal, and a communication path 103 that connects the sender 101 and the receiver 102. In quantum cipher communication system 100, the sender 101 sends any secret information toward the receiver 102 through the communication path 103. The secret information includes shared common key used in the common key cryptosystem.

The receiver 102 has an optical source 110, a circulator 112, a beam-splitter 114 having a 1:1 split ratio, a phase-modulator 116, delaying device 118, a beam-splitter 120, a polarizing beam-splitter 122, detectors 124, 126, an optical switch 128, a variable attenuator 130, a homodyne detector 132, a switch circuit 134, a controller 136, and a signal source 138.

The sender 101 has a beam-splitter 150, a delaying device 152, a variable attenuator 154, a phase-modulator 156, an optical switch 158, a Faraday mirror 160, detectors 162, 164, a switch circuit 166, a controller 168, and a signal source 170.

The communication path 103 includes an optical fiber or a free space. As the free space is used as the communication path 103, it is possible to suppress an adverse influence of diffraction of light by using any telescope to make a diameter of optical beam larger in the communication path 103.

The following will describe processing details of each component of the quantum cipher communication system 100 according to an operation sequence of the communication processing thereof to which quantum cipher is applied.

In the quantum cipher communication system 100, the receiver 102 first sends the sender 101 pulse light emitted from the optical source 110 in the receiver 102 through the communication path 103. The receiver then receives data return from the sender 101 through the communication path 103. The following operations will describe based on such the processing order.

The circulator 112 in the receiver 102 performs optical paths so that light emitted from the optical source 110 can be output to the beam-splitter 114 and light return from the beam-splitter 114 can be output to the homodyne detector 132.

When the beam-splitter 114 receives pulse light emitted from the optical source 110 through the circular 112 in the receiver 102, the beam-splitter 114 splits the received pulse light into pulse light P1 as signal light and pulse light P2 a reference light. The pulse light P1 is propagated from the beam-splitter 114 to the polarizing beam-splitter 122 passing through the phase-modulator 116, the delaying device 118, and the beam-splitter 120. The pulse light P2 is propagated from the beam-splitter 114 to the polarizing beam-splitter 122 passing through the optical switch 128. In FIG. 1, solid lines indicate the pulse light P1, P2 that propagate from the receiver 102 to the sender 101 as well as dotted lines indicate the pulse light P1, P2 that propagate from the sender 101 back to the receiver 102.

These two paths extending from the beam-splitter 114 to the polarizing beam-splitter 122 is constituted of polarization maintain fibers each of which is connected to each component. When the pulse light P1, P2 is synthesized in the polarizing beam-splitter 122 and output to the communication path 103, the pulse light P1, P2 is orthogonal to each other to form linear polarization.

The delaying device 118 delays the pulse light P1. This enables the pulse light P1 to be propagated into the communication path 103 with the pulse light P1 being delayed as compared with the pulse light P2. A time difference in the pulse light P1, P2 is selected so that it can be sufficient longer than coherent time of the pulse light emitted from the optical source 110 and it can be made longer than response time of the phase-modulator 116 in the receiver 102 or response time of the phase-modulator 156 and the variable attenuator 154.

The sender 101 receives the pulse light P1, P2 from the receiver 102 through the communication path 103. In the sender 101, the beam-splitter 150 receives the pulse light P1, P2 via the communication path 103. The beam-splitter 150 splits the received pulse light P1, P2 into two parts, a majority part and a minority part, and outputs the majority part to the delaying device 152 and only the minority part to the detector 164.

Split ratio of the beam-splitter 150 can be set so that most of the light can be propagated into a side of the delaying device 152 but the detector 164 can detect an arrival of the pulse light P2. For example, the split ratio of the beam-splitter 150 is set to a 9:1 split ratio between the side of the delaying device 152 and the side of the detector 164.

The detector 164 is used for monitoring the arrival of the pulse light P2. The detector 164 includes photodiode or avalanche photodiode combined by an amplifier. To the photodiode or avalanche photodiode, silicon Si may be used in a case where wavelength of the pulse light stays in a visible range or a near-infrared range. Alternatively, germanium Ge or InGaAs may be used in a case where wavelength of the pulse light stays in a range from 1.3 μm to 1.6 μm. It is to be noted that other detectors are also configured similar to the configuration of the detector 164, which will not be described.

The detector 164 supplies its detected output to the controller 168 and the signal source 170 through the switch circuit 166. Although, in FIG. 1, the variable attenuator 154 stays nearer the communication path 103 than the phase-modulator 156, the phase-modulator 156 can stay nearer the communication path 103 than the variable attenuator 154.

The controller 168 controls the phase-modulator 156 and the variable attenuator 154. In the moment, the variable attenuator 154 has a high transmission factor on the pulse light P2 but the phase-modulator 156 does not act thereon. On the other hand, the variable attenuator 154 has a large amount of attenuation and low transmission factor on the pulse light P1, and then the phase-modulator 156 performs any adequate phase modulation processing thereon.

The controller 168 also controls a timing of phase-modulation-processing start on the pulse light P1 (signal light) in the phase-modulator 156 by acquiring the arrival of the pulse light P2 (the reference light) based on the detected output from the detector 164. This allows phase modulation processing in the phase-modulator 156 to be performed at proper timing on the each pulse constituting the pulse light P1 (the signal light).

For example, in a case where a quantum cipher using four quantum states is carried out, phase modulations of zero degrees (0 radian), 90 degrees (Π/2 radian), 180 degrees (Π radian), and 270 degrees (3Π/2 radian) are applied to each pulse at random. The variable attenuator can be constituted of acousto-optic element or LiNbO₃ intensity modulator. The phase-modulator 156 can be constituted of LiNbO₃ phase modulator.

The Faraday mirror 160 in the sender 101 reflects the pulse light P1, P2 received by the sender 101 from the receiver 102 through the communication path 103 and the reflected light is returned to the receiver 102. Therefore, the pulse light P1, P2 pass through the variable attenuator 154 and the phase-modulator 156 in the sender 101 twice back and forth. An amount of attenuation in the variable attenuator 154 is set so that an average photon number can become about one item for each pulse of the pulse light P1 that is returned from the sender 101 to the receiver 102.

Thus, because any communication security is maintained in the quantum cipher communication system, the pulse light P1 as the signal light is made weak. In this embodiment, the sender 101 has photon-number-setting device that sets to a predetermined value the average photon number of the signal light that is sent to the communication path 103. The beam-splitter 150, the optical switch 158, the detectors 162, 164, and the controller 168 constitute this photon-number-setting device. The photon-number-setting device may include the variable attenuator 154. How to set the average photon number of the pulse light P1 by the photon-number-setting device will be described later.

Further, an average photon number for each pulse of the pulse light P2 that is returned from the sender 101 to the receiver 102 is selected so that a signal-to-noise (S/N) ratio of the homodyne detector 132 in the receiver 102 can be made optimal. The typical intensity of the pulse light P2 indicates the average photon number of about 10⁶ items for each pulse thereof. A typical relative ratio of transmission factors of the pulse light P1 to the pulse light P2 indicates about 10⁻⁶:1.

Thus, such the homodyne detection method is a method for measuring a state of the signal light with the weak signal light (which has the average photon number of about one item for each pulse) being overlapped to the relative strong reference light (which has the typical average photon number of about 10⁶ items for each pulse). In this embodiment, the pulse light P1 that is returned from the sender 101 to the receiver 102 corresponds to a signal light having an average photon number of about one item for each pulse thereof. The pulse light P2 that is returned from the sender 101 to the receiver 102 corresponds to a reference light having an average photon number of about 10⁶ items for each pulse thereof.

Both of the phase-modulator 156 and the variable attenuator 154 in the sender 101 give phase modulation and attenuation that are not depended on any polarization state of the pulse light which is reached at the sender 101 from the communication path 103. The Faraday mirror that reflects the pulse light P1, P2 can satisfy this automatically. If the acousto-optic element is used as the variable attenuator 154, it has a transmission factor that is not almost depended on the polarization state of the pulse light. In this case, the transmission factor of the variable attenuator 154 on the pulse light P1 is set to about 10⁻³ for each time.

The receiver 102 receives the attenuated pulse light, the pulse light P1, and the non-attenuated pulse light, the pulse light P2, both of which are processed by the above processing in the sender 101, through the communication path 103. The attenuated pulse light P1 corresponds to the signal light and the non-attenuated pulse light P2 corresponds to the reference light.

The polarizing beam-splitter 122 receives the pulse light P1 (the signal light) and the pulse light P2 (the reference light) received by the receiver 102 from the sender 101 through the communication path 103 and splits the received light. In this moment, the pulse light P1 is output to a short path that is connected to the beam-splitter 114 through the optical switch 128. The pulse light P2 is output to a long path that is connected to the beam-splitter 114 through the beam-splitter 120, the delaying device 118, and the phase-modulator 116. In FIG. 1, the dotted lines respectively indicate the pulse light P1 (the signal light) and the pulse light P2 (the reference light).

Since the Faraday mirror reflects the pulse light P1, P2 in the sender 101, the pulse light P1, P2 returned to the polarizing beam-splitter 122 of the receiver 102 is linearly polarized so that their plane of polarization can rotate by 90 degrees respectively with respect to the pulse light P1, P2 sent from the receiver 102.

Based on such the polarization, the polarizing beam-splitter 122 outputs the pulse light P1 received by the receiver 102 to the short path to transmit the polarized pulse light P1 to the beam-splitter 114 through the optical switch 128. The polarizing beam-splitter 122 also outputs the pulse light P2 received by the receiver 102 to the long path to transmit the polarized pulse light P2 to the beam-splitter 114 through the beam-splitter 120, the delaying device 118, and the phase-modulator 116.

Relative to the pulse light P1, P2 when the pulse light P1, P2 is sent from the receiver 102 to the sender 101 and when the pulse light P1, P2 is returned from the sender 101 to the receiver 102, their passing paths between the polarizing beam-splitter 122 and the beam-splitter 114 in the receiver 102 are interchanged.

In this embodiment, since the weak pulse light P1 (the signal light) that is attenuated by the attenuation processing in the sender 101 is passed through the short path in which extra optics do not exist, this quantum cipher communication system 100 can have less optical loss in the pulse light P1 that is returned to the receiver 102.

The beam-splitter 120 splits the pulse light P2 (the reference light) having the typical average photon number of about 10⁶ items for each pulse into two parts thereof, a pulse light part propagated to the delaying device 118 and a pulse light part propagated to the detector 126. A typical split ration of the beam-splitter 120 is set to 9:1 so that a majority of the pulse light can be propagated to a side of the delaying device 118.

The detector 126 of the receiver 102 has the same configuration as that of the detector 164 of the sender 101. The split ratio of the beam-splitter 120 can be set so that most of the light can be propagated into a side of the delaying device 118 but the detector 126 can detect an arrival of the pulse light P2.

The detector 126 supplies its output to the controller 136 and the signal source 138 through the switch circuit 134. The controller 136 controls the phase-modulator 116 and controls a timing of reading output from the homodyne detector 132.

The controller 136 can also control a timing of phase-modulation-processing start on the pulse light P2 (reference light) in the phase-modulator 116 by acquiring the arrival of the pulse light P2 (reference light) based on the detected output from the detector 126. This allows phase modulation processing in the phase-modulator 116 to be performed at proper timing on the each pulse constituting the pulse light P2 (reference light).

The phase-modulator 116 also performs any random phase modulation on the pulse light P2 passed through the delaying device 118 for each pulse. In a case where a quantum cipher using four quantum states is carried out, phase modulation of zero degrees (0 radian) or 90 degrees (Π/2 radian) is applied to each pulse at random.

In the path in which the pulse light P1 is sent from the receiver 102 to the sender 101, the pulse light P1 passes through the long path in which the pulse light P1 is propagated from the beam-splitter 114 to the polarizing beam-splitter 122 through the phase-modulator 116, the delaying device 118, and the beam-splitter 120 while, in the path in which the pulse light P1 is returned from the sender 101 to the receiver 102, the pulse light P1 passes through the short path in which the pulse light P1 is propagated from the polarizing beam-splitter 122 to the beam-splitter 114 through the optical switch 128.

In the path in which the pulse light P2 is sent from the receiver 102 to the sender 101, the pulse light P2 passes through the short path in which the pulse light P2 is propagated from the beam-splitter 114 to the polarizing beam-splitter 122 through the optical switch 128 while, in the path in which the pulse light P2 is returned from the sender 101 to the receiver 102, the pulse light P2 passes through the long path in which the pulse light P2 is propagated from the polarizing beam-splitter 122 to the beam-splitter 114 through the beam-splitter 120, the delaying device 118, and the phase-modulator 116.

Thus, the pulse light P1, P2 passes through the paths that have the exactly same distance to each other during a shuttle of the receiver 102 and the sender 101 so that the pulse light P1 (the signal light) and the pulse light P2 (the reference light) can arrive at the beam-splitter 114 at the same time.

The pulse light P1 is the signal light having a quantum-mechanical quality and the pulse light P2 is the reference light (referred to also as “local oscillation light” having more intensity than that of the pulse light P1. In this embodiment, the pulse light P1 is used as the signal light and the pulse light P2 is used as the reference light so that the homodyne detection is performed on the pulse light P1. One of two outputs from the beam-splitter 114 is supplied to the homodyne detector 132 through the variable attenuator 130 while the other is supplied to the homodyne detector 132 through the circulator 112.

At two input portions of the homodyne detector 132, photodiodes are respectively mounted. As the photodiode, silicon Si may be used in a case where wavelength of the pulse light stays in a visible range or a near-infrared range. Alternatively, germanium Ge or InGaAs may be used in a case where wavelength of the pulse light stays in a range from 1.3 μm to 1.6 μm. Amplifier having a high gain and low noise characteristic receives outputs of the two photodiodes. When output from the amplifier is standardized by using an intensity of the pulse light P2 (the reference light), gain of the amplifier and the like, orthogonal phase amplitude of the pulse light P1 (the signal light can be obtained. From such the information detected by the homodyne detector 132, any secret information, for example, common key can be obtained.

In this embodiment, the receiver 102 can have a photon-number-estimating device that estimates an average photon number of the pulse light P1 (the signal light) which is sent to the communication path 103 from the sender 101. The receiver 102 can also have a photo-number-verifying device for verifying that the estimated average photon number of the pulse light P1 in the photon-number-estimating device is made identical to the set average photon number of the pulse light P1 in the photon-number-setting device in the sender 101. These photon-number-estimating device and photo-number-verifying device will be described later.

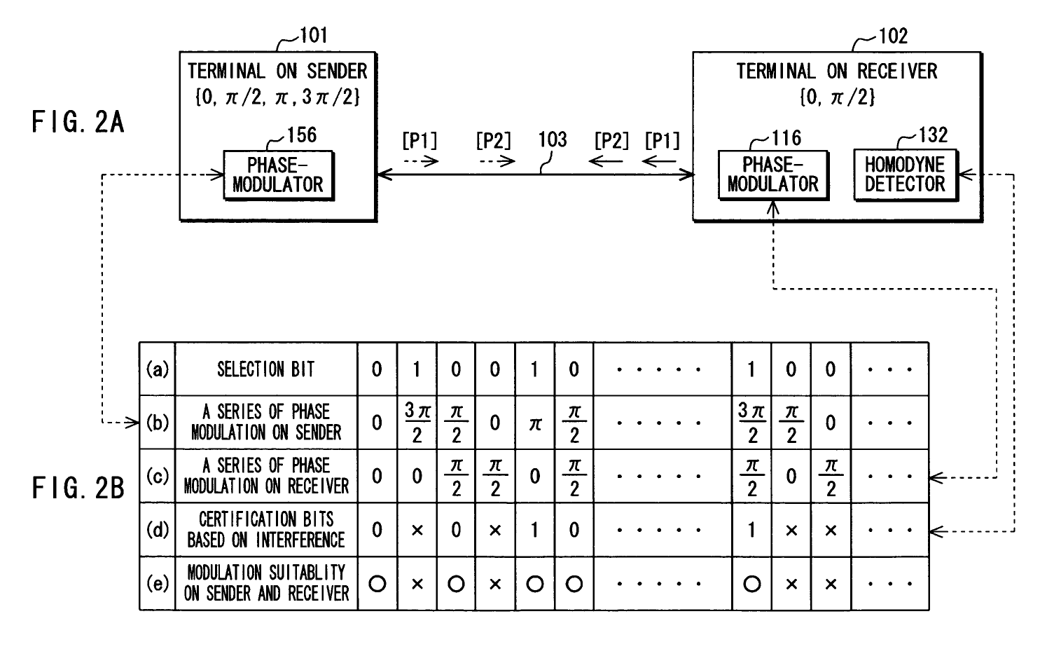

The following will describe an outline of shared sequence of the secret information by means of any communication between the sender 101 and the receiver 102 with reference to the attached FIGS. 2 through 4.

As shown in FIG. 2A, the receiver 102 first sends the pulse light P1, P2 to the sender 101 and the sender 101 then sends the pulse light P1, P2 back to the receiver 102. In this moment, the phase-modulator 156 of the sender 101 performs a phase modulation of any one of 0 radian, Π/2 radian, Π radian, and 3Π/2 radian on the pulse light P1 (the signal light) of the pulse light P1, P2 that are received from the receiver 102. In a table of FIG. 2B, row (b) shows a series of such the phase modulation on a sender.

The series of phase modulation shown in the row (b) of the table of FIG. 2B, which the sender 101 performs on the pulse light P1, may be selected at random. Alternatively, after the selection bit shown in the row (a) of the table of FIG. 2B is previously set, any modulation may be performed corresponding to the selection bit. It is to be noted that the 0 bit corresponds to phase modulation light of 0 radian or Π/2 radian and 1 bit corresponds to phase modulation light of Π radian or 3Π/2 radian.

The variable attenuator 154 (see FIG. 1) sends such the phase-modulated pulse light P1 as the attenuated signal light back to the receiver 102. The pulse light P2 (the reference light) is also sent back to the receiver without being attenuated. The pulse light P1 that is sent from the sender 101 back to the receiver 102 is weak signal light (which has an average photon number of about one item for each pulse) and the pulse light P2 that is sent from the sender 101 back to the receiver 102 is relatively intensive reference light (which has a typical average photon number of 10⁶ items for each pulse).

When the receiver 102 receives the pulse light P1 (the signal light) and the pulse light P2 (the reference light) that are sent from the sender 101, the phase-modulator 116 selects any one from, for example, 0 radian and Π/2 radian at random to perform the selected phase modulation on the pulse light P2 (the reference light) and the homodyne detector 132 measures an interference phenomenon.

For example, when the phase-modulator 116 of the receiver 102 performs the phase modulation shown in row (c) of the table in FIG. 2B thereon, the homodyne detector 132 can detect bits shown in row (d) of the table in FIG. 2B. Relative to data identified by the certificated bits based on the interference, 0 bit and 1 bit indicate that the bit certification based on the interference is successfully carried out and a character x indicates that the bit certification based on the interference is failed. It is determined by a combination of phase modulation processing performed in the sender 101 and the receiver 102 whether or not the bit certification is successfully carried out.

For example, as data on the certification bits based on the interference shown in row (d) of the table in FIG. 2B, the 0 bit and 1 bit can be detected only when the combination of the combination of phase modulation processing satisfies a predetermined condition.

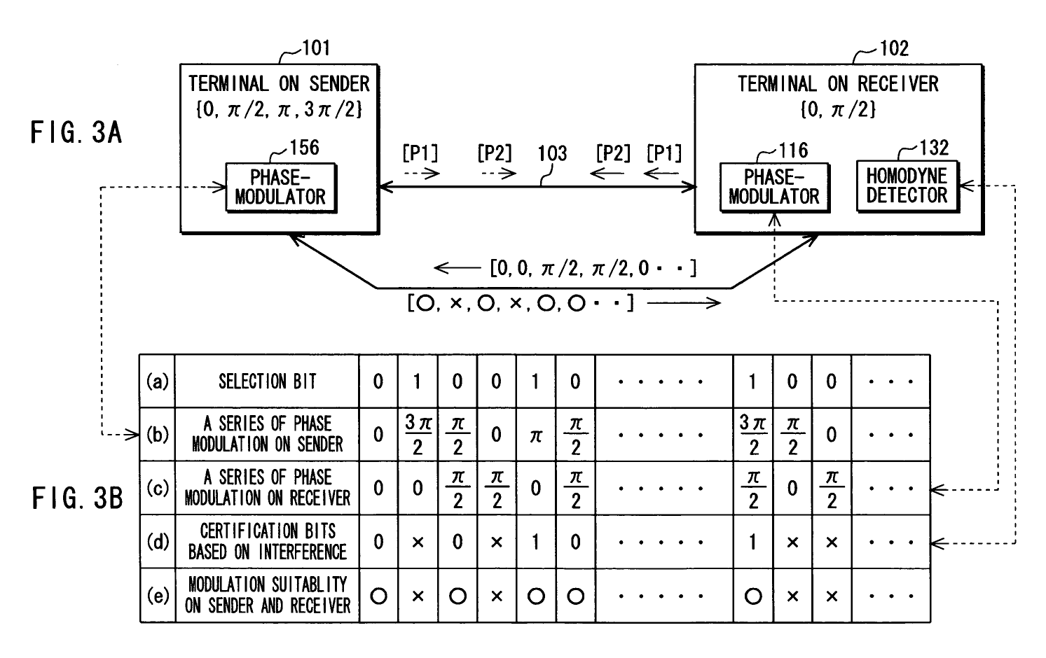

The receiver 102 then informs the sender 101 of information on a series of phase modulation which is applied thereto in the receiver 102, namely, a series of information shown in row (c) of the table in FIG. 3B. Such the series of information is indicated in FIG. 3A as [0, 0, Π/2, Π/2,0 . . . ].

The sender 101 produces information on columns of the table in which proper modulation suitable for bit detection is successfully carried out and improper modulation suitable for bit detection is carried out and sends it to the receiver 102. Namely, the sender 101 sends a series of information shown in row (e) of the table in FIG. 3B to the receiver 102. Such the series of information is indicated in FIG. 3A as [o, x, o, x, o, . . . ].

It is to be noted that the series of information indicated as [0, 0, Π/2, Π/2, 0. . . ] can be sent from the receiver 102 to the sender 101 through a public communication path and the series of information indicated as [o, x, o, x, o, o . . . ] can be also sent from the sender 101 to the receiver 102 through the public communication path 103.

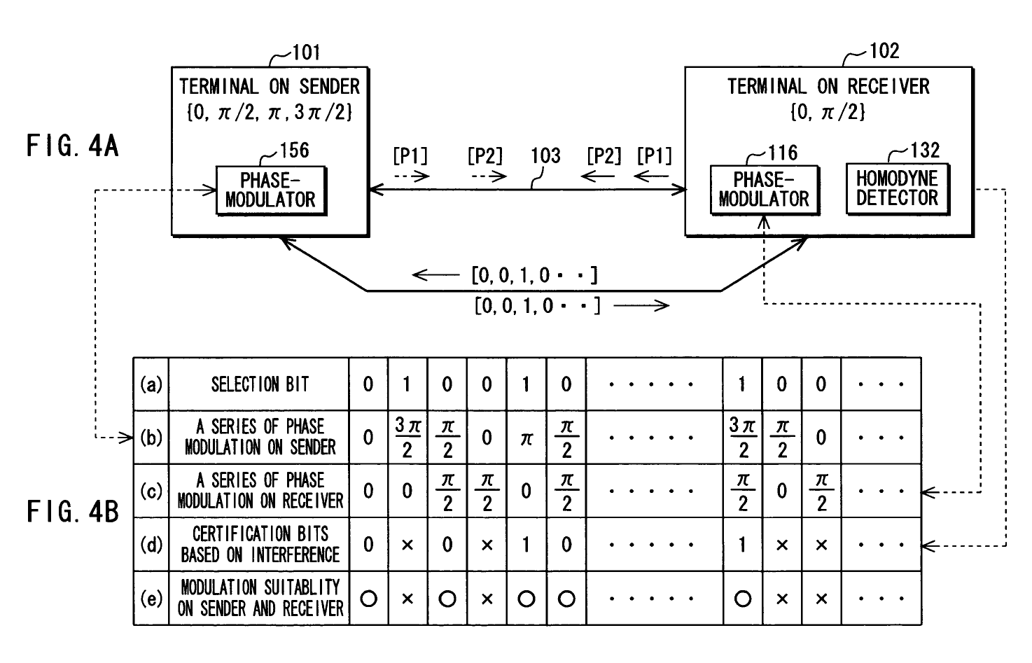

As shown in FIG. 4, the receiver 102 informs the sender 101 of a series of the detected bit information. Such the series of the bit information is indicated in FIG. 4A as [0, 0, 1, 0. . . ]. The sender 101 informs the receiver 102 of information on a series of only bits that is phase-modulated and can be detected by the receiver 102. Such the series of the bits is indicated in FIG. 4A as [0, 0, 1, 0. . . ]. These bits are a series of only bits that are selected from the selection bits shown in row (a) of the table in FIG. 4B and that stay in the columns circled in the row (e) of the table in FIG. 4B. They can be also sent from the sender 101 to the receiver 102 and vice versa through the public communication path.

If no communication data is tapped in the communication path 103, all the certificated bits agree with each other in the intercommunication of bits shown in FIG. 4A. If communication data is tapped in the communication path 103, the certificated bits do not agree with each other in the intercommunication of bits shown in FIG. 4A so that any difference occurs in the intercommunicated bits. This is because tapping in the communication path 103 causes their modulation situation to alter. If no communication data is tapped in the communication path 103, any difference does not occur in the intercommunicated bits.

Such the data communication allows to be shared the secret information, for example, common key in the common key cryptosystem. It is to be noted that if the common key of n bits is shared, after certifying that the intercommunicated bits as described with reference to FIGS. 4A, 4B agree with each other, the common key of n bits is selected from m bits (m>n) that are shared by the above processing according to any common bit-selection processing that has been mutually communicated in advance.

According to the embodiment shown in FIG. 1, the communication path in which the receiver 102 sends information to the sender and vice versa is formed between the sender and the receiver; and propagation distance of the pulse light P2 used for the reference light (local oscillation light) is made equal to that of the pulse light P1 used for the signal light so that the pulse light P2 used for the reference light is reached at the beam-splitter 114 in the receiver 102 at the completely same timing as that the pulse light P1 used for the signal light is reached at the beam-splitter 114. This enables any interference measurement in the homodyne detector 132 to be accurately performed.

In specific terms, the pulse light P1, P2 is propagated through the optical paths between the beam-splitter 114 and the polarizing beam-splitter 122 so that the pulse light P1, P2 can be propagated through the replaced optical paths when the pulse light P1, P2 is sent from the receiver 102 to the sender 101 and vice versa. This enables the propagated distance of the pulse light P1 that is sent from the receiver 102 to the sender 101 and vice versa to be made identical to that of the pulse light P2 that is sent from the receiver 102 to the sender 101 and vice versa, thereby allowing any interference measurement in the homodyne detector 132 to be accurately performed.

Next, the following will describe details of the photon-number-setting device provided in the sender 101, and the photon-number-estimating device and the photo-number-verifying device that are provided in the receiver 102.

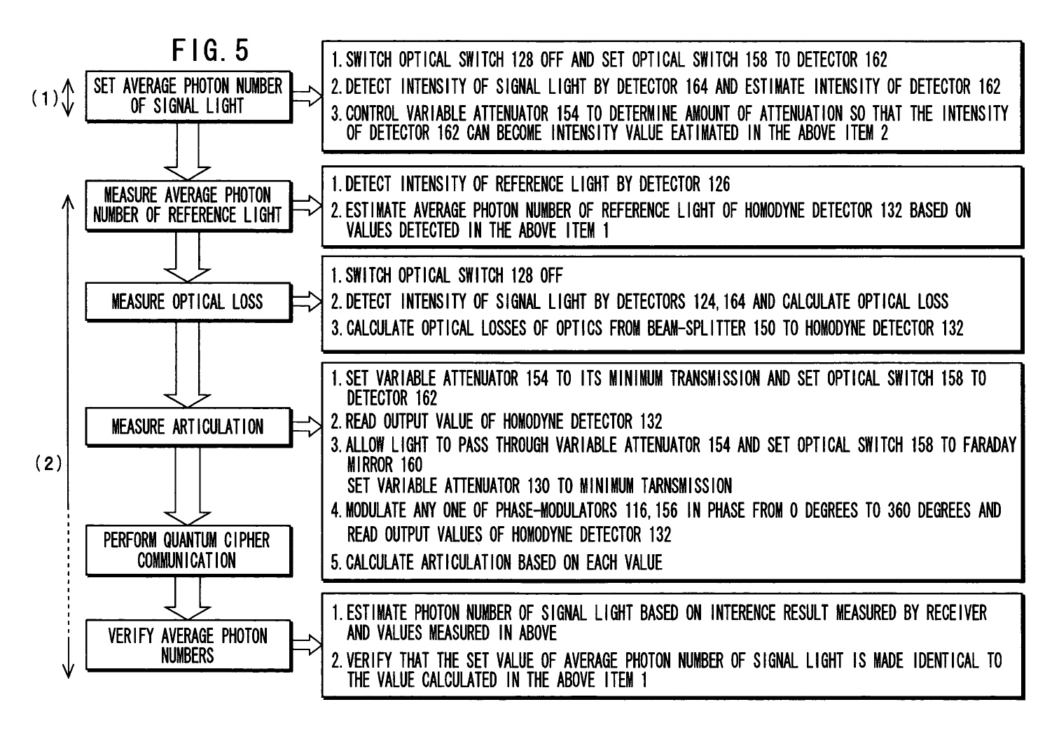

FIG. 5 is a flowchart for showing procedures of average photo number setting of the signal light in the photon-number-setting device, average photon number estimating of the signal light in the photon-number-estimating device, and average photon number verifying of the signal light in the photo-number-verifying device. In the quantum cipher communication system 100, the controller 136 of the receiver 102 and the controller 168 of the sender 101 hold such the procedure as shown in this flowchart.
(1) The following will describe a procedure of average photon number setting of the signal light.

The average photon number of the signal light is first searched so that the average photon number can become a predetermined value at an output of the sender 101, namely, a point that the signal light is input from the beam-splitter 150 to the communication path 103. According to the quantum key distribution protocol, the pulse light P1 (the signal light) is propagated from the beam-splitter 114 of the receiver 102 to the sender 101 through the beam-splitter 114, the phase-modulator 116, the delaying device 118, the beam-splitter 120, the polarizing beam-splitter 122 of the receiver 102 via the communication path 103. In this moment, in order to allow the sender 101 to receive only the pulse light P1 from the communication path 103, the optical switch 128 of the receiver 102 is switched off to intercept the pulse light P2 (the reference light).

Next, the detector 164 of the sender 101 detects intensity (power) of the pulse light P1. In this moment, the detector 164 constitutes a first detector. This detected intensity value is supplied to the controller 168 through the switch circuit 166. The controller 168 estimates the intensity value of the detector 162 of the sender 101 based on the detected intensity value of the detector 164 and the set value of average photon number of the pulse light P1 (the signal light) to be sent from the sender 101 to the communication path 103. In this moment, the controller 168 constitutes an intensity-estimating device.

Further, the optical switch 158 is switched to a side of the detector 162. The detector 162 detects intensity of the pulse light P1 (the signal light) after the pulse light is attenuated in the variable attenuator 154. The detected intensity value by the detector 162 is supplied to the controller 168. In this moment, the detector 162 constitutes a second detector. The controller 168 controls the variable attenuator 154 to determine an amount of the attenuation thereof so that the detected intensity value of the detector 162 can become the above estimated intensity value of the detector 162. In this moment, the controller 168 constitutes an amount-of-attenuation-directing device.

It is to be noted that if attenuation of the variable attenuator 154 is stable and the attenuation when the pulse light is transmitted at maximum level is known, it is possible to detect intensity of the pulse light P1 (the signal light) as performed with the detector 164 by using the detector 162 and the variable attenuator 154. In this case, the detected intensity value of the pulse light P1 by the detector 162 when the pulse light is transmitted at maximum level in the variable attenuator 154 is replaced with the detected intensity value by the detector 164. In the moment, the detector 162 constitutes a first detector in addition to the second detector.

According to the above procedure, it is possible to set the average photon number of the pulse light P1 (the signal light) to the predetermined value, for example, about one item of the average photon number for each pulse at an output of the sender 101, namely, a point in which the pulse light P1 is propagated from the beam-splitter 150 to the communication path 103.
(2) The following will describe procedures of average photon number estimating of the signal light and average photon number verifying of the signal light.

The average photon number of the pulse light P1 (the signal light) that is sent from the sender 101 to the communication path 103 is first estimated. The estimated average photon number and the set average photon number of the pulse light P1 (the signal light), which has been set in the sender 101, are verified so that the estimated average photon number of the signal light P1 can be made identical to the set average photon number of the signal light. This allows wiretap to be detected.

Based on the output from the homodyne detector 132 and each parameter value, the average photon number of the pulse light P1 (the signal light) is first estimated. Namely, the controller 136 in the receiver 102 estimates the average photon number of the pulse light P1 (the signal light) that is sent from the sender 101 to the communication path 103 based on the following expression (1).
N₀−N₁₈₀=4*V*√(S*L*E*L₀) (1)
where N₀, N₁₈₀ are respectively outputs from the homodyne detector 132 when the phase is 0 degrees and 180 degrees, V is articulation, S is the average photon number of the signal light, L is an optical loss in path between the beam-splitter 150 of the sender 101 and the homodyne detector 132 of the receiver 102, E is quantum efficiency, ad L₀ is the average photon number of the reference light.

This estimation value can be used as the reference value for detecting the wiretap. In this moment, the controller 136 constitutes the photon-number-estimating device.

Measurement of the average photon number L₀ of the reference light, the optical loss L, and the articulation V is performed before the sender 101 has sent any secret information to the receiver 102, for example, quantum cipher communication, as shown in FIG. 5.

Measurement of the average photon number L₀ of the reference light will be performed by using the detector 126 that receives only the pulse light P2 (the reference light). The detected intensity value of the detector 126 is supplied to the controller 136 through the switch circuit 134. The controller 136 estimates the average photon number of the reference light at the homodyne detector 132 based on the intensity value detected by the detector 126.

Measurement of the optical loss L will be performed as follows: The loss in the unstable communication path 103 can be calculated by detecting the intensity of the pulse light P1 (the signal light) by the detectors 124, 164 with the optical switch 128 being switched off. Because the optics other than the communication path are estimated as to be stable, the optical loss L is calculated based on the loss in the communication path 103 calculated above and the losses in other optics. It is to be noted that if the variable attenuator 154 and the delaying device 152 are stable, instead of the detector 164, the detector 162 can be used to detect intensity of the pulse light P1 (the signal light).

Measurement of the articulation V will be performed as follows: the variable attenuators 130, 154 are first set to their minimum transmission and the optical switch 158 is switched to a side of the detector 162 in order to stop reflecting by Faraday mirror 160. In this situation, an output R0 from the homodyne detector 132 is read. The attenuator 154 changes its attenuation to a transmission factor such that the homodyne detector 132 is not overflowed and the optical switch 158 is switched to a side of the Faraday mirror 160.

The phase-modulators 116, 156 modulate the pulse light in phase from 0 degrees to 360 degrees and outputs of the homodyne detector 132 are read at each of the amounts of the modulation. The articulation V is calculated by the following expression:
V=(R1−R2)/(R1+R2−2×R0)
where R1 is a maximum value and R2 is a minimum value.

The controller 136 of the receiver 102 estimates the average photon number S of the signal light based on the above expression (1) using the measured average photon number L₀ of the reference light, the measured optical loss L, and the measured articulation V after the quantum cipher communication (quantum key distribution protocol) is performed. In this moment, as N₀, N₁₈₀, outputs of the homodyne detector 132 that are obtained when the quantum cipher communication is performed and amounts of phase modulation are 0 degrees and 180 degrees are used.

The controller 136 of the receiver 102 verifies that a set value of the average photon number of the pulse light P1 (the signal light) that is sent from the sender 101 to the communication path 103 is made identical to the estimated average photon number of the pulse light P1 (the signal light). Such the verification allows wiretap to be detected. In this moment, the controller 136 constitutes photon-number-verifying device.

Thus, according to the quantum cipher communication system 100 shown in FIG. 1, the sender 101 has the photon-number-setting device that sets an average photon number of the pulse light P1 (the signal light) at its output to a predetermined value, for example, about one item of the average photon number for each pulse. The photon-number-setting device can set an average photon number of the pulse light P1 accurately at the output of the sender 101. Verifying that the set average photon number of the pulse light P1 is made identical to the average photon number of the pulse light P1 that is estimated in the receiver 102 enables the wiretap to be easily detected.

It is to be noted that in the quantum cipher communication system 100 shown in FIG. 1, the detectors 126, 164 have converted optical signals to electric signals and the switch circuits 134, 166 respectively have enabled the electric signals to branch into two ways, for example, the controller 136 and the signal source 138 as well as the controller 168 and the signal source 170. This invention, however, is not limited to such the configuration. The detectors 126, 164 can be replaced with the optical switches and the detectors are respectively set before the controller and the signal source so that outputs of the two optical switches can be connected to each of the detectors.

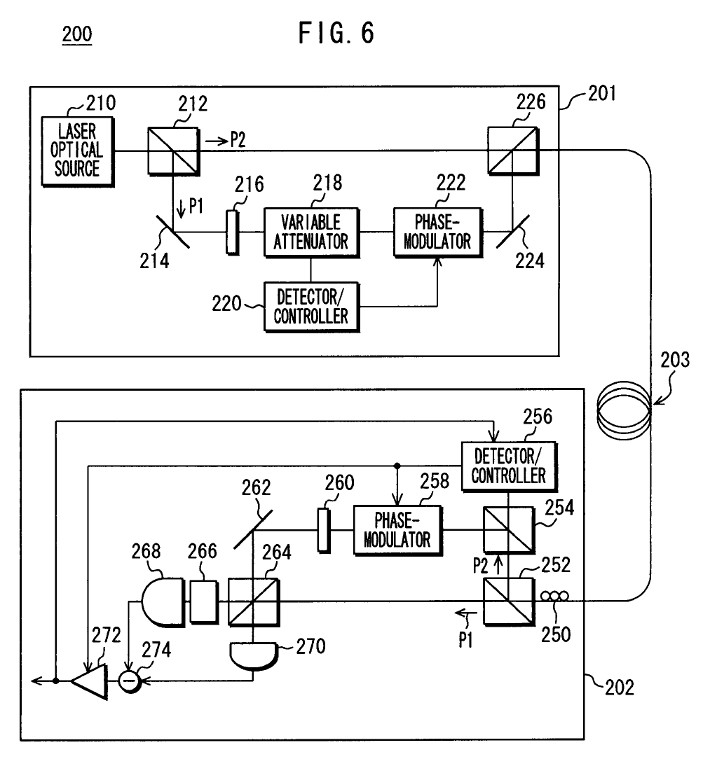

The following will describe another embodiment of a quantum cipher communication system 200 according to the invention. FIG. 6 shows a configuration of the quantum cipher communication system 200.

The quantum cipher communication system 200 has a terminal 201 on a sender side (hereinafter referred to as “sender 201”) as a second communication terminal, a terminal 202 on a receiver side (hereinafter referred to as “receiver 202”) as a first communication terminal, and a communication path 203 constituted of, for example, optical fiber, that connects the sender 201 and the receiver 202. In quantum cipher communication system 200, the sender 201 sends any secret information toward the receiver 202 through the communication path 203. The secret information includes shared common key used in the common key cryptosystem.

The sender 201 has an optical source 210, a beam-splitter 212, a reflecting mirror 214, a half-wavelength plate 216, a variable attenuator 218, a detector/controller 220, a phase-modulator 222, a reflecting mirror 224, and a polarizing beam-splitter 226.

The receiver 202 has a polarization element 250, a polarizing beam-splitter 252, a beam-splitter 254, a detector/controller 256, a phase-modulator 258, a half-wavelength plate 260, a reflecting mirror 262, a beam-splitter 264, a variable attenuator 266, photodiodes 268, 270, an amplifier/voltage-measuring device 272, and a subtractor 274.

In this quantum cipher communication system 200, one directional communication from the sender 201 to the receiver 202 is performed and by using polarization of light, the signal light and the reference light are controlled on separate optical paths. A synchronizing signal of the sender 201 is obtained by separating a part of the signal light by means of the variable attenuator 218 that is provided on an optical path through which the signal light is passed. In the receiver 202, a beam-splitter 254 is provided on an optical path through which the reference light is passed so that a part of the reference light can be used for a synchronizing signal of the receiver 202.

The following describe processing details of each component of the quantum cipher communication system 200 according to an operation sequence of the communication processing thereof to which quantum cipher is applied.

In the quantum cipher communication system 200, the beam-splitter 212 in the sender 201 receives pulse light from the laser optical source 210 and splits the received pulse light into pulse light P1 as signal light and pulse light P2 a reference light. The pulse light P1 (the signal light) is propagated from to the polarizing beam-splitter 226 passing through a third optical path. Along the third optical path, the reflecting mirror 214, the half-wavelength plate 216, the variable attenuator 218, the phase-modulator 222, and the reflecting mirror 224 are arranged in this order.

The half-wavelength plate 216 enables a polarizing surface of the received pulse light P1 to rotate only by 90 degrees. The variable attenuator 218 attenuates intensity of the received pulse light P1. The variable attenuator 218 corresponds to the variable attenuator 154 in the sender 101 of the quantum cipher communication system 100 shown in FIG. 1. An amount of attenuation in the variable attenuator 218 is set so that an average photon number can become about one item for each pulse of the pulse light P1 that is sent from the sender 201 to the communication path 203.

On the other hand, an average photon number for each pulse of the pulse light P2 that is sent from the sender 201 to the receiver 202 is set so that a signal-to-noise (S/N) ratio of the homodyne detector in the receiver 202 can be made optimal. The typical intensity of the pulse light P2 indicates the average photon number of about 106 items for each pulse thereof. The phase-modulator 222 corresponds to the phase-modulator 156 in the sender 101 of the quantum cipher communication system 100 shown in FIG. 1. For example, in a case where a quantum cipher using four quantum states is carried out, phase modulations of zero degrees (0 radian), 90 degrees (Π/2 radian), 180 degrees (Π radian), and 270 degrees (3Π/2 radian) are applied to each pulse at random.

Light leaked from the variable attenuator 218 accompanying with its attenuation processing is supplied to the detector/controller 220 which detects an arrival of the pulse light P1. The detector/controller 220 then controls any processing starts of phase modulation on the pulse light P1 (the signal light) in the phase-modulator 222 based on this detected result. This enables phase modulation on each pulse constituting the pulse light P1 (the signal light) in the phase-modulator 222 to be performed at their correct timings.

As described above, it is because any security of the communication is maintained as the quantum cipher communication system that the variable attenuator 218 attenuates the pulse light P1 (the signal light) to be made weak. In this embodiment, the sender 201 has a photon-number-setting device that sets the average photon number thereof to a predetermined one. The variable attenuator 218 and the detector/controller 220 constitute the photon-number-setting device. How to set the average photon number of the pulse light P1 by the photon-number-setting device will be described later.

The pulse light P2 (the reference light) split by the beam-splitter 212 is propagated to the polarizing beam-splitter 226 passing through a fourth optical path that is shorter than the third optical path. This polarizing beam-splitter 226 synthesizes the pulse light P1 (the signal light) and the pulse light P2 (the reference light) and sends the synthesized pulse light P1 and pulse light P2 to the communication path 203. Such the pulse light P1 and pulse light P2 have polarizing surfaces that are orthogonal to each other and are separated from each other in time. In this moment, this polarizing beam-splitter 226 constitutes a light-sending device.

The receiver 203 receives the pulse light P1 (the signal light) and the pulse light P2 (the reference light) that are sent from the sender 201 to the receiver 202. The polarization element 250 is provided at a side of the receiver 202 on the communication path 203. The polarization element 250 is used for correcting any disturbance in the polarization during an optical fiber communication. The polarizing beam-splitter 252 splits the synthesized pulse light that is sent from the sender 201 through the communication path 203 into the pulse light P1 (the signal light) and the pulse light P2 (the reference light).

The pulse light P1 (the signal light) is propagated to the beam-splitter 264 passing through a second optical path having an optical length which corresponds to that of the fourth optical path of the above sender 201. The pulse light P2 (the reference light) is propagated to the beam-splitter 264 passing through a first optical path having an optical length which corresponds to that of the third optical path of the above sender 201.

Along the first optical path, the beam-splitter 254, the phase-modulator 258, the half-wavelength plate 260, and the reflecting mirror 262 are arranged in this order. The beam-splitter 254 splits the received pulse light P2 (the reference light) into a pulse light that is propagated to the phase-modulator 258 and a pulse light that is propagated to the detector/controller 256. The typical split ratio of the beam-splitter 254 is set to a 9:1 split ratio between the side of the phase-modulator 258 and the side of the detector/controller 256. Thus, the pulse light is set so that its majority is propagated to the side of the phase-modulator 258.

The detector/controller 256 controls the phase-modulator 258 and the amplifier/voltage-measuring device 272. The detector/controller 256 can detect an arrival of the pulse light P2 (the reference light) based on the detected output of the pulse light split in the beam-splitter 254 and controls processing starts of phase modulation on the pulse light P2 (the reference light) in the phase-modulator 258. This enables phase modulation on each pulse constituting the pulse light P2 (the reference light) in the phase-modulator 258 to be performed at their correct timings.

The phase-modulator 258 corresponds to the phase-modulator 116 in the receiver 102 of the quantum cipher communication system 100 shown in FIG. 1 and performs any random phase modulation on the pulse light P2 for each pulse. In a case where a quantum cipher using four quantum states is carried out, phase modulation of zero degrees (0 radian) or 90 degrees (Π/2 radian) is applied to each pulse at random.

The half-wavelength plate 260 rotates a polarizing surface of the pulse light P2 (the reference light) by only 90 degrees. As described above, in the sender 201, the pulse light P1 (the signal light) is propagated to the longer third optical path and has a polarizing surface rotated by 90 degrees by means of the half-wavelength plate 216 but the pulse light P2 (the reference light) is propagated to the shorter fourth optical path while, in the receiver 202, the pulse light P1 (the signal light) is propagated to the shorter second optical path but the pulse light P2 (the reference light) is propagated to the longer first optical path and has a polarizing surface rotated by 90 degrees by means of the half-wavelength plate 260. This enables the pulse light P1, P2 to be reached at the beam-splitter 264 at the same timing and to have the same polarization direction.

Two outputs from the beam-splitter 264 are supplied to the homodyne detector. One of the outputs from the beam-splitter 264 is supplied to a photodiode 270 constituting the homodyne detector while the other of the outputs is also supplied to the photodiode 268 constituting the homodyne detector through the variable attenuator 266.

The subtractor 274 subtracts output of the photodiode 268 from the output of the photodiode 270 to provide a difference signal. The amplifier/voltage/measuring device 272 amplifies this difference signal and measures the voltage thereof. The output from the amplifier/voltage-measuring device 272 is detection information of the homodyne detector, from which any communication secret information, for example, a shared secret key can be obtained.

In this embodiment, the receiver 202 has photon-number-estimating device that estimates an average photon number of the pulse light P1 (the signal light) sent to the communication path 203 from the sender 201, and photo-number-verifying device verifying that the estimated average photon number of the pulse light P1 in the photon-number-estimating device is made identical to the set average photon number of the pulse light P1 in the sender 201. These photon-number-estimating device and photo-number-verifying device will be described later.

Sequences of sharing the secret information in the communication between the sender 201 and the receiver 202 in the quantum cipher communication system 200 shown in FIG. 6 are similar to those (see FIGS. 2, 3, and 4) of sharing the secret information in the communication between the sender 101 and the receiver 102 in the quantum cipher communication system 100 shown in FIG. 1., any details of which will not described.

The following will describe procedures of the average photo number setting of the signal light in the photon-number-setting device in the sender 201, and average photon number estimating of the signal light in the photon-number-estimating device and average photon number verifying of the signal light in the photo-number-verifying device of the receiver 202.
(1) The following will describe a procedure of average photon number setting of the signal light in the photon-number-setting device.

The average photon number of the signal light is first searched so that the average photon number can become a predetermined value at an output of the sender 201, namely, a point that the signal light is input from the polarizing beam-splitter 226 to the communication path 203. The detector of the detector/controller 220 detects intensity of light leaked from the variable attenuator 218 accompanying with its attenuation processing. The controller of the detector/controller 220 can obtain intensity of the pulse light P1 output from the variable attenuator 218 based on the detected value of the intensity of light leaked from the variable attenuator 218 if the intensity of the pulse light P1 (the signal light) that the variable attenuator 218 receives is known.

The controller of the detector/controller 220 also controls the variable attenuator 218 to determine its amount of the attenuation so that average photon number of the pulse light P1 (the signal light) that is sent from the sender 201 to the communication path 203 can become a predetermined value based on the above detected value of the intensity of the leaked light and the set value of the average photon number of the pulse light P1 (the signal light) that is sent from the sender 201 to the communication path 203. In this moment, the detector/controller 220 in the sender 201 constitutes an amount-of-attenuation-directing device.

According to the above procedures, an amount of attenuation in the variable attenuator 218 is set so that the average photon number of the pulse light P1 (the signal light) can become a predetermined value, for example, about one item for each pulse at an output from the sender 201, a place from which light from the polarizing beam-splitter 226 is induced into the communication path 203.
(2) The following will describe procedures of average photon number estimating of the signal light and average photon number verifying of the signal light.

The average photon number of the pulse light P1 (the signal light) that is sent from the sender 201 to the communication path 203 is first estimated. The estimated average photon number and the set average photon number of the pulse light P1 (the signal light), which has been set in the sender 201, are verified so that the estimated average photon number of the signal light P1 can be made identical to the set average photon number of the signal light. This allows wiretap to be detected.

Similar to a case of the controller 136 in the receiver 102 of the quantum cipher communication system 100 as shown in FIG. 1, based on the output from the homodyne detector and each parameter value, the detector/controller 256 of the receiver 202 estimates average photon number of the pulse light P1 (the signal light). Namely, the detector/controller 256 in the receiver 202 estimates the average photon number of the pulse light P1 (the signal light) that is sent from the sender 201 to the communication path 203 based on the above expression (1). In this moment, the detector/controller 256 constitutes the photon-number-estimating device.

Measurement of the average photon number L₀ of the reference light will be performed by using the detector of the detector/controller 256 that detects a part of the pulse light P2 (the reference light) split by the beam-splitter 254. The controller of the detector/controller 256 estimates the average photon number of the reference light at the homodyne detector based on the intensity value detected by the detector.

Measurement of the optical loss L will be performed as follows: Although the pulse light P1 (the signal light) is directly incident to the beam-splitter 264 in a regular mode through the polarizing beam-splitter 252 in the receiver 202, adjusting the polarization element 250 enables the pulse light P1 (the signal light) to propagate to the beam-splitter 254.

Then, based on detected value of the intensity of light leaked from the variable attenuator 218 accompanying with its attenuation processing by the detector of the detector/controller 220 and detected value of the intensity of light split from the beam-splitter 254 by the detector of the detector/controller 256, loss in the communication path 203 can be calculated. Because the optics other than the communication path are estimated as to be stable, the optical loss L is calculated based on the loss in the communication path 203 calculated above and the losses in other optics.

Measurement of the articulation V will be performed as follows. The variable attenuator 266 is first set to its minimum transmission and the variable attenuator 218 is set so that the intensity of the pulse light P1 (the signal light) and that of the pulse light P2 (the reference light) can be made identical to each other, which can be set by measuring loss of each element previously. Then, the phase-modulator 222 or 258 modulates the pulse light in phase from 0 degrees to 360 degrees and outputs of the homodyne detector (the amplifier/voltage-measuring device 272) are read at each of the amounts of the modulation. The articulation V is calculated by the following expression:
V=(R1−R2)/(R1+R2−2×R0)
where R1 is a maximum value; R2 is a minimum value; and off-set value R0 is an output value of the homodyne detector when no light is incident.

The detector/controller 256 of the receiver 202 estimates the average photon number S of the signal light based on the above expression (1) using the measured average photon number L₀ of the reference light, the optical loss L, and the articulation V after the quantum cipher communication is performed. In this moment, as N₀, N₁₈₀, outputs of the homodyne detector that are obtained when the quantum cipher communication is performed and amounts of phase modulation are 0 degrees and 180 degrees are used.

The controller of the detector/controller 256 of the receiver 202 verifies that a set value of the average photon number of the pulse light P1 (the signal light) that is sent from the sender 201 to the communication path 203 is made identical to the estimated average photon number of the pulse light P1 (the signal light). Such the verification allows wiretap to be detected. In this moment, the detector/controller 256 constitutes photon-number-verifying device.

Thus, according to the quantum cipher communication system 200 shown in FIG. 6, the sender 201 has the photon-number-setting device that sets an average photon number of the pulse light P1 (the signal light) at its output to a predetermined value, for example, about one item of the average photon number for each pulse. The photon-number-setting device can set an average photon number of the pulse light P1 accurately at the output of the sender 201. Verifying that the set average photon number of the pulse light P1 (the signal light) is made identical to the average photon number of the pulse light P1 that is estimated in the receiver 202 enables the wiretap to be easily detected.

According to the above embodiments of the invention, it is possible to set the average photon number of the pulse light P1 (the signal light) at the output of the sender accurately and to detect the wiretap easily. The above embodiments of the invention are applicable to a case where any secret information, for example, a secret key in common key cryptosystem, is shared.

It should be understood by those skilled in the art that various modifications, combinations, sub-combinations and alternations may occur depending on design requirements and other factors insofar as they are within the scope of the appended claims or the equivalents thereof.

1. A quantum cipher communication system that performs communication processing based on quantum cipher, said system comprising:
a first communication terminal;
a second communication terminal; and
a communication path that connects the first communication terminal and the second communication terminal,
wherein the first communication terminal contains:
an optical source that emits pulse light;
a first light-separating device that separates signal light and reference light from the pulse light emitted from the optical source;
a first optical path into which a delaying device is inserted;
a second optical path into which no delaying device is inserted;
a light-synthesizing device that synthesizes the signal light separated in the first light-separating device and passed through the first optical path with the reference light separated in the first light-separating device and passed through the second optical path to send the synthesized light to the communication path;
a second light-separating device that separates the signal light and the reference light from the pulse light returned from the second communication terminal through the communication path;
a first phase-modulator that performs random phase-modulation on the reference light separated in the second light-separating device and passed through the first optical path for each pulse; and
a homodyne detector that performs homodyne detection based on the reference light separated in the second light-separating device and passed through the first optical path and the signal light separated in the second light-separating device and passed through the second optical path;
wherein the second communication terminal contains:
a light-sending device that sends the signal light and the reference light to the communication path via a predetermined optical path, the signal light and the reference light being sent from the first communication terminal through the communication path;
an optical attenuator that attenuates the signal light passing through the predetermined optical path;
a second phase-modulator that performs random phase-modulation on the signal light passing through the predetermined optical path for each pulse; and
a photon-number-setting device that sets to a predetermined value an average photon number of the signal light that is sent to the communication path from the light-sending device.

2. The quantum cipher communication system according to claim 1 wherein the photon-number-setting device in the second communication terminal further contains:
a first detector that detects an intensity of the signal light sent from the first communication terminal through the communication path;
a second detector that detects an intensity of the signal light after the signal light is attenuated by the optical attenuator;
an intensity-estimating device that estimates an intensity value of the second detector based on the detected intensity of the first detector and the set value of the average photon number of the signal light that is sent to the communication path; and
an amount-of-attenuation-directing device that directs an amount of attenuation in the optical attenuator with the detected intensity of the second detector becoming the estimated intensity value of the second detector in the intensity-estimating device.

3. The quantum cipher communication system according to claim 1 wherein the first communication terminal further contains a photon-number-estimating device that estimates an average photon number of the signal light which is sent to the communication path from the second communication terminal.

4. The quantum cipher communication system according to claim 3 wherein the first communication terminal further contains a photo-number-verifying device, said photo-number-verifying device verifying that the estimated average photon number of the signal light in the photon-number-estimating device is made identical to the set average photon number of the signal light in the photon-number-setting device in the second communication terminal.

5. The quantum cipher communication system according to claim 1 wherein the first communication terminal further contains:
a first light-splitting device that splits a part of the reference light sent from the second communication terminal through the communication path;
a first light-detecting device that detects an arrival of the reference light based on a split output from the first light-splitting device; and
a first process-controlling device that controls processing starts of the first phase-modulator and the homodyne detector based on a detected output from the first light-detecting device,
wherein the second communication terminal further contains:
a second light-splitting device that splits a part of the light sent from the first communication terminal through the communication path;
a second light-detecting device that detects an arrival of the reference light based on a split output from the second light-splitting device; and
a second process-controlling device that controls processing starts of the second phase-modulator and the optical attenuator based on a detected output from the second light-detecting device.

6. A method of setting an average photon number at a communication terminal that contains light-sending device sending signal light which has sent through a communication path to the communication path via a predetermined optical path and an optical attenuator attenuating the signal light passing through the predetermined optical path, said method comprising:
detecting an intensity of the signal light sent from the communication terminal through the communication path;
estimating an intensity value of the signal light after the signal light is attenuated in the optical attenuator based on the intensity of the signal light detected in the detecting step and the set value of the average photon number of the signal light that is sent to the communication path by the light-sending device; and
directing an amount of attenuation in the optical attenuator with the intensity of the signal light after the signal light is attenuated becoming the intensity value estimated in the intensity-value-estimating step.

7. A quantum cipher communication system that performs communication processing based on quantum cipher, said system comprising:
a first communication terminal;
a second communication terminal; and
a communication path that connects the first communication terminal and the second communication terminal,
wherein the first communication terminal contains:
a first light-separating device that separates signal light and reference light from light sent from the second communication terminal through the communication path;
a first optical path;
a second optical path having a shorter length than that of the first optical path;
a first phase-modulator that performs random phase-modulation on the reference light separated in the first light-separating device and passed through the first optical path for each pulse; and
a homodyne detector that performs homodyne detection based on the reference light separated in the first light-separating device and passed through the first optical path and the signal light separated in the first light-separating device and passed through the second optical path;
wherein the second communication terminal contains:
an optical source that emits pulse light;
a second light-separating device that separates the signal light and the reference light from the pulse light emitted from the optical source;
a third optical path having a length of optical path that corresponds to that of first optical path of the first communication terminal;
a fourth optical path having a length of optical path that corresponds to that of the second optical path of the first communication terminal;
an optical attenuator that attenuates the signal light passing through the third optical path;
a second phase-modulator that performs random phase-modulation on the signal light passing through the third optical path for each pulse;
a light-sending device that synthesizes the signal light separated in the second light-separating device and passed through the third optical path with the reference light separated in the second light-separating device and passed through the fourth optical path to send the synthesized light to the communication path; and
a photon-number-setting device that sets to a predetermined value an average photon number of the signal light that is sent to the communication path from the light-sending device.

8. The quantum cipher communication system according to claim 7 wherein the photon-number-setting device in the second communication terminal further contains:
a detector that detects an intensity of light leaked from the optical attenuator accompanying with its attenuation processing; and
an amount-of-attenuation-directing device that directs an amount of attenuation in the optical attenuator based on the detected intensity of the detector and the set value of the average photon number of the signal light that is sent to the communication path from the light-sending device.

9. The quantum cipher communication system according to claim 7 wherein the first communication terminal further contains a photon-number-estimating device that estimates an average photon number of the signal light sent from the second communication terminal through the communication path.

10. The quantum cipher communication system according to claim 9 wherein the first communication terminal further contains a photo-number-verifying device, said photo-number-verifying device verifying that the estimated average photon number of the signal light in the photon-number-estimating device is made identical to the set average photon number of the signal light in the photon-number-setting device in the second communication terminal.

11. A method of setting an average photon number at a communication terminal that contains light-sending device sending light emitted from an optical source to a communication path through a predetermined optical path and an optical attenuator attenuating the signal light passing through the predetermined optical path, said method comprising:
detecting an intensity of light leaked from the optical attenuator accompanying with its attenuation processing; and
directing an amount of attenuation in the optical attenuator based on the intensity of the leaked light detected in the intensity-detecting step and the set value of the average photon number of the signal light that is sent to the communication path from the light-sending device.
